(19) United States
(12) Patent Application Publication
(10) Pub. No.: US 2026/0097658 A1
(43) Pub. Date: Apr. 9, 2026

(54) REDUNDANT SYSTEM FOR IMPLEMENTING A CONTROLLED STOP IN AN AUTONOMOUS DRIVING SYSTEM

(71) Applicant: Rivian IP Holdings, LLC, Irvine, CA (US)

(72) Inventors: Thomas James EMERY, Morgan Hill, CA (US); Daniel James SLIPPER, Wigston (GB); Kevin Jared SALLEE, Lake Forest, CA (US); Bhuvanesh SAINATH, Irvine, CA (US); Michael James HIBBARD, Long Beach, CA (US); Joseph Daniel HIMMELHEBER, Redondo Beach, CA (US); Anna Malin EKHOLM, Laguna Beach, CA (US)

(21) Appl. No.: 18/911,134

(22) Filed: Oct. 9, 2024

(51) Int. Cl. B60L 3/00; B60L 7/16; B60L 7/24; B60L 15/00; B60L 50/53

(52) U.S. Cl. CPC B60L 3/0076; B60L 3/0084; B60L 7/16; B60L 7/24; B60L 15/007; B60L 50/53; B60L 2210/10; B60L 2260/32

(57) ABSTRACT

A vehicle includes a driving braking system configured to decelerate the vehicle. The vehicle further includes an electronic parking brake system configured to maintain a position of the vehicle when parked. An autonomous driving controller is configured to autonomously drive the vehicle. The autonomous driving controller is further configured to detect failure of the driving braking system and, in response to detecting failure of the driving braking system, perform a controlled stop using the electronic parking brake system. The driving braking system and the electronic parking brake may receive power from different voltage sources. The autonomous driving controller may be connected to the driving braking system and the electronic parking brake by two busses.

### INTRODUCTION

The present disclosure relates to a redundant system for implementing a controlled stop in an autonomous driving system.

### SUMMARY

The present disclosure describes an approach for implementing a redundant braking system. In one aspect, a vehicle includes a driving braking system configured to decelerate the vehicle. The vehicle further includes an electronic parking brake system configured to maintain a position of the vehicle when parked. An autonomous driving controller is configured to autonomously drive the vehicle. The autonomous driving controller is further configured to detect failure of the driving braking system and, in response to detecting failure of the driving braking system, perform a controlled stop using the electronic parking brake system.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2 is a schematic block diagram of components for operating the vehicle in accordance with certain embodiments.

FIGS. 3A to 3C are schematic block diagrams illustrating redundant braking systems for various vehicle configurations in accordance with certain embodiments.

FIG. 4 is a process flow diagram of a method for performing a controlled stop using a redundant braking system in accordance with certain embodiments.

### DETAILED DESCRIPTION

The society of automotive engineers (SAE) level 3 autonomous driving standard applies to vehicles that can autonomously manage most aspects of driving, including monitoring the environment, without human intervention. According to the SAE level 3 autonomous driving standard, a control system must have the ability to control the vehicle velocity (e.g., perform a controlled stop) in response to a failure.

A redundant braking system is described herein that includes three different braking options: regenerative braking, friction braking (e.g., hydraulic), and an electronic parking brake. All three options are available to perform a controlled stop in response to a failure of the other two. In addition, the redundant braking system includes two voltage domains with independent power sources, the electronic parking brake being coupled to both voltage domains. There may be two vehicle motion controllers in the two voltage domains, one of which is active at any given time. There may also be two separate control area network (CAN) busses connecting the vehicle motion controllers to the electronic parking brake, friction braking system, and vehicle motion controllers.

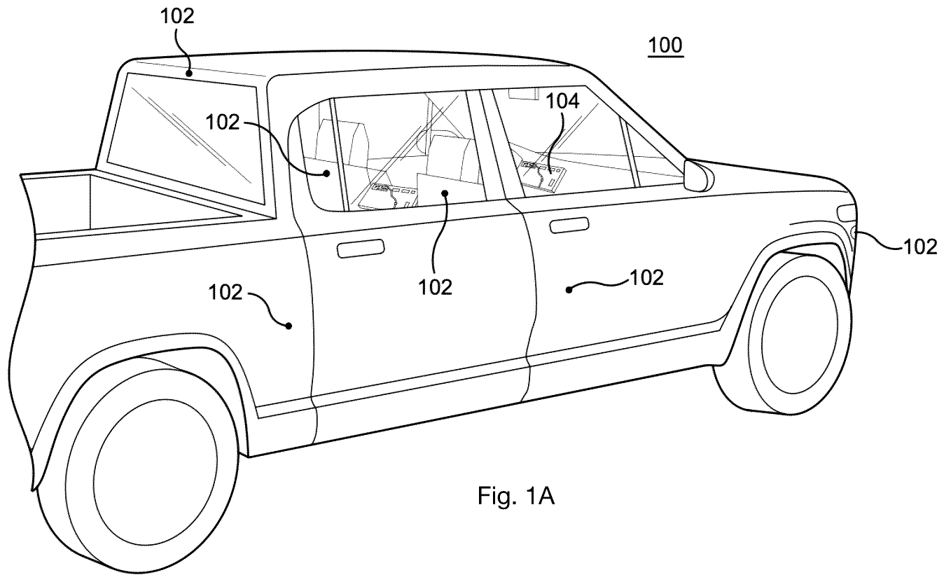

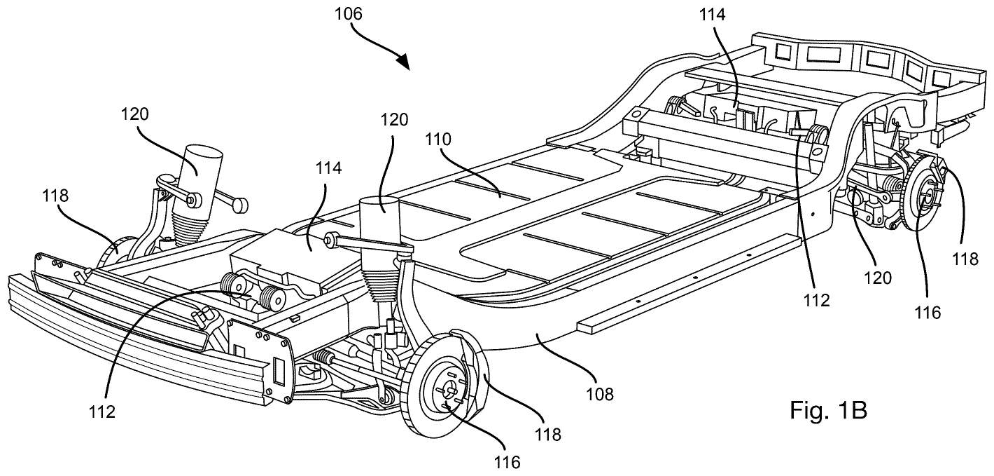

FIG. 1A illustrates an example vehicle 100 in which the approach described herein may be implemented. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (e.g., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100. In still other embodiments, there are three drive units 112 with one drive unit 112 driving the front wheels and two drive units 112 driving the rear wheels or two drive units 112 driving the front wheels and one drive unit 112 driving the rear wheels.

Power from the battery 110 may be supplied to the drive units 112 by one or more sets of power module 114, such as power module for each drive unit 112 or pair of drive units 112. The power module 114 may include inverters configured to convert direct current (DC) from the battery 110 into alternating current (AC) supplied to the motors of the drive units 112. The power module 114 further facilitate operation of the motors of the drive units as generators to provide regenerative braking. The power module 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, a hybrid-electric vehicle may also benefit from the approach described herein. Likewise, non-vehicular applications that use an inverter or other relevant power component may also benefit from the approach described herein.

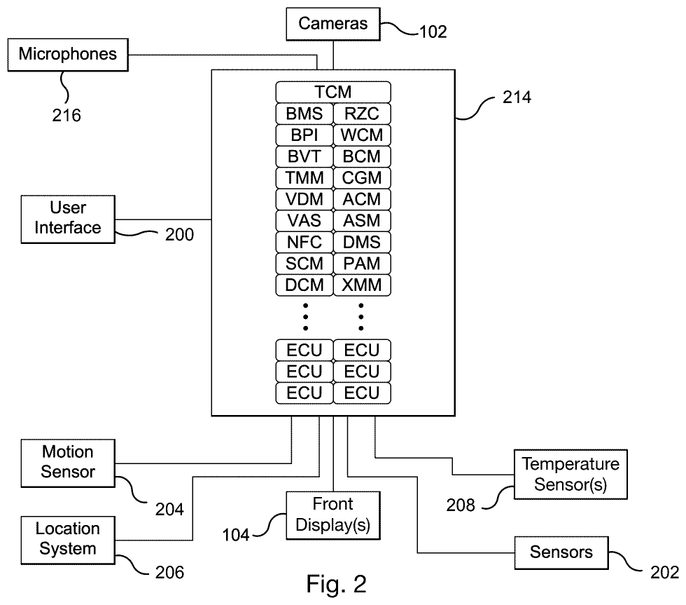

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of a power module 114, temperature of each drive unit 112 and/or each motor of each drive unit 112, temperature of coolant fluid entering or leaving a coolant system, temperature of oil within a drive unit 112, or the temperature of any other component of the vehicle 100. The temperature sensors 208 may include a temperature sensor directly mounted to a microprocessor of the power module 114.

A control system 214 executes instructions to perform at least some of the actions or functions of the vehicle 100. For example, as shown in FIG. 2, the control system 214 may include one or more electronic control units (ECUs) configured to perform at least some of the actions or functions of the vehicle 100, including the functions described herein. In certain embodiments, each of the ECUs is dedicated to a specific set of functions.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for processing.

The control system 214 may also include one or more additional ECUs, such as, by way of example and not limitation: a Vehicle Dynamics Module (VDM) ECU, Friction Brake Controller, Steering Controller, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

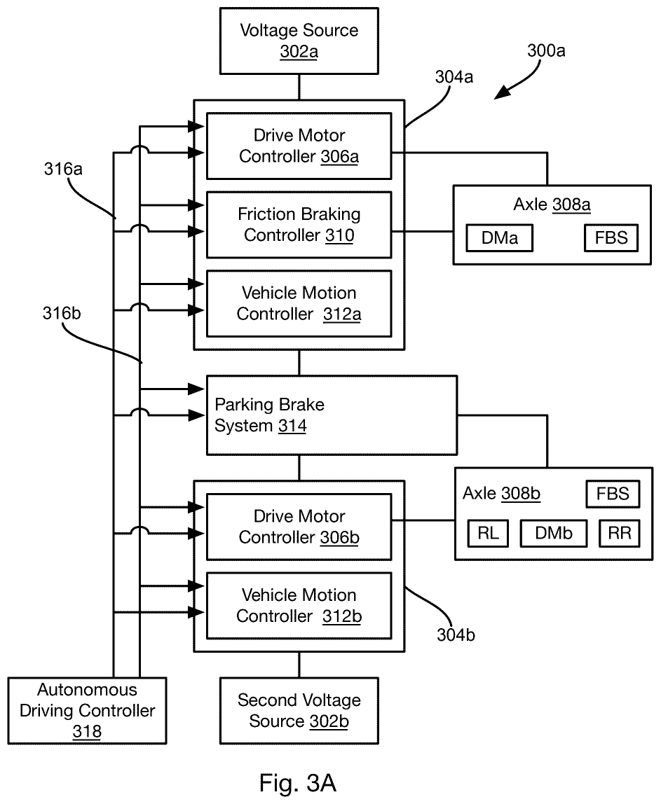

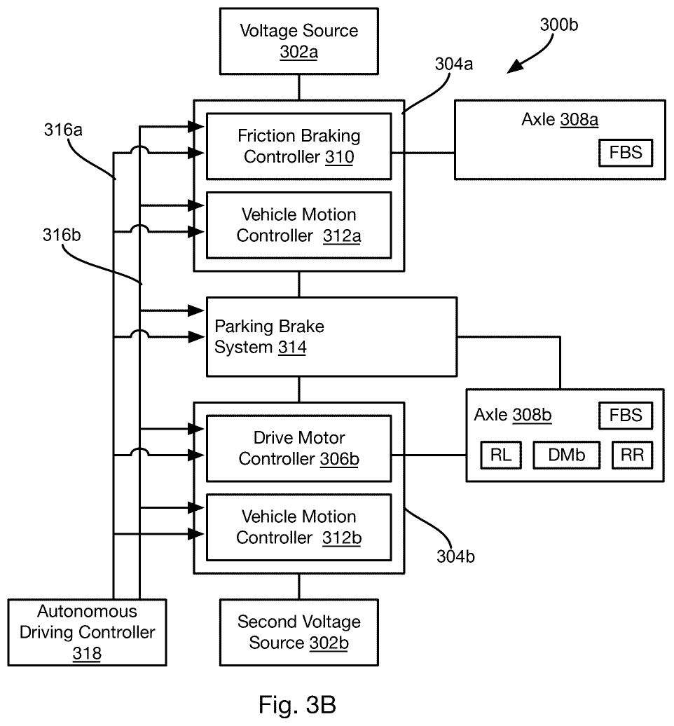

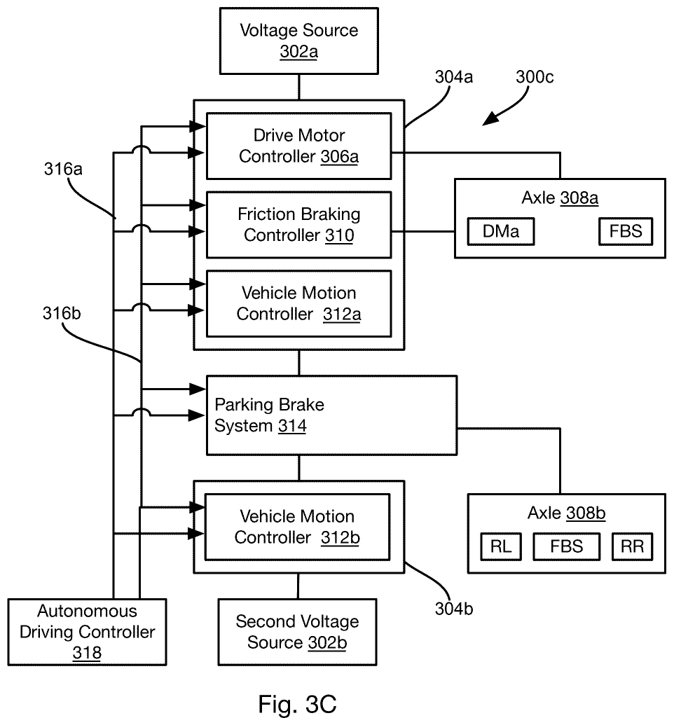

Referring to FIG. 3A, a redundant braking system 300a may include two voltage sources 302a, 302b. For example, voltage source 302a may be a 12-volt (V) or higher battery other than the battery 110, such as a voltage of between 12 and 48 V. The voltage source 302b may be another 12 V or higher battery other than the battery 110. The voltage source 302b may also be the battery 110 in combination with a direct current to direct current (DC/DC) converter that reduces the voltage of the battery, such as to a voltage between 12 and 48 V or some other voltage.

The voltage sources 302a, 302b may define different voltage domains 304a, 304b, respectively, including wiring, relays, and/or other components conveying voltage from the voltage sources 302a, 302b.

For example, in an all-wheel-drive (AWD) vehicle 100, there may be separate drive motor controllers 306a, 306b for separate drive motors DMa, DMb. For example, the drive motor controllers 306a, 306b may include (or be included in) power module 114 and may include inverter switches for controlling the supply of current to drive motors DMa, DMb. Each drive motor controller 306a, 306b may control the application of torque to a different axle 308a, 308b, such as a front axle and a rear axle. In other embodiments, there may be three or four drive motors and corresponding drive motor controllers controlling supply to three or four different axles. In such embodiments, at least one drive motor controller may be in a different voltage domain 304a than the remaining drive motor controllers. The drive motor controllers 306a, 306b are further configured to control the flow of current from corresponding drive motors DMa, DMb in order to generate regenerative current and corresponding regenerative braking.

A friction braking controller 310 may be in one or both of the voltage domains 304a, 304b, such as in the voltage domain 304a. The friction braking controller 310 controls the application of torque to an axle, such as to one or both of the axles 308a, 308b, by a friction braking system FBS. For example, the friction braking system FBS may be a hydraulic braking system such that the friction braking controller 310 controls electronic valves supplying hydraulic oil to hydraulic brakes. The friction braking controller 310 may provide an interface for electronic control of the friction braking system FBS with the driver using a brake pedal to mechanically control the friction braking system.

The friction braking system FBS along with regenerative braking provided by the drive motor controllers 306a, 306b and corresponding drive motors DMa, DMb constitutes a driving braking system of the vehicle 100. The driving braking system is that which is used to decelerate the vehicle 100 while driving. The driving braking system may be invoked by a driver engaging a brake pedal or by an automated driving system, such as the autonomous driving controller 318 (see below), adaptive cruise control, or the like.

Each voltage domain 304a, 304b may include a vehicle motion controller 312a, 312b. Each vehicle motion controller 312a, 312b is an electronic component that determines an amount of drive torque or braking torque. Each vehicle motion controller 312a is configured to command the drive motor controllers 306a, 306b to achieve the determined amount of drive torque. Each vehicle motion controller 312a is further configured to command the drive motor controllers 306a, 306b and/or friction braking system FBS to achieve the determined amount of braking torque.

In some embodiments, one vehicle motion controller 312a is primary and will always function as a vehicle motion controller absent failure. The other vehicle motion controller 312b is secondary and may have a different primary function such that the other vehicle motion controller 312b only functions as vehicle motion controller in the event of failure of the vehicle motion controller 312a. For example, the vehicle motion controller 312a may be part of the vehicle dynamics module (VDM) whereas the vehicle motion controller 312b is incorporated into any of the other ECUs listed above with respect to FIG. 2.

A parking brake system 314 may be connected to both voltage domains 304a, 304b. The parking brake system 314 may include circuits managing failover from a primary voltage domain (e.g., voltage domain 304a) to a secondary voltage domain (e.g., voltage domain 304b). The parking brake system 314 may include controllers and actuators configured to apply friction to disks, drums, or other structures coupled to an axle of the vehicle 100, such as the axle 308b. For example, the parking brake system 314 may include a rear left (RL) actuator configured to prevent rotation of a rear left wheel coupled to the axle 38b and a rear right (RR) actuator configured to prevent rotation of a rear right wheel coupled to the axle 308b. The parking brake system 314 may be configured as any electronic parking brake system known in the art. In the illustrated embodiment, the parking brake system 314 applies braking force to the rear wheels. However, other implementations are possible, such as those that apply braking force to the front wheels or to all four wheels.

The parking brake system 314 may be distinguished from the driving braking system in that the parking brake system 314, absent a failure of the driving braking system, does not provide braking in response to driver actuation of a brake pedal and is likewise not instructed to provide braking by an autonomous driving controller 318 (see below). Likewise, the driving braking system may remain disengaged when the vehicle is placed in park and the parking brake system 314 is providing braking.

Some or all of the drive motor controllers 306a, 306b, friction braking controller 310, vehicle motion controllers 312a, 312b, and parking brake system 314 may be coupled to a controller area network (CAN) bus 316a. In some embodiments, some or all of the drive motor controllers 306a, 306b, friction braking controller 310, vehicle motion controllers 312a, 312b, and parking brake system 314 are additionally connected to another CAN bus 316b. The CAN bus 316b may be inactive and unused in the absence of failure of the CAN bus 316a. Circuits within components coupled to the CAN busses 316a, 316b may manage failover from one CAN bus 316a to the other CAN bus 316b. In other embodiments, both CAN busses 316a, 316b are active simultaneously. Accordingly, components connected to the CAN busses 316a, 316b may arbitrate which of the busses 316a, 316b to use at any given time. In such embodiments, components may detect failure of a bus 316a, 316b and automatically switch over to exclusive use of the functional bus 316b, 316a. One or both of the CAN busses 316a, 316b may be substituted with an alternative communication medium, such as Ethernet, FLEXRAY, or the like.

An autonomous driving controller 318 implements an autonomous driving algorithm. The autonomous driving controller 318 may therefore receive the outputs of the sensors 202 that sense an environment of the vehicle 100. The autonomous driving controller 318 may implement an SAE level 3 autonomous driving system according to any approach known in the art. The autonomous driving controller 318 may be implemented by the control system 214, such as by one or more ECUs within the control system 214. The autonomous driving controller 318 may likewise be connected to both CAN busses 316a, 316b.

The autonomous driving controller 318 interfaces with some or all of the drive motor controllers 316a, 316b, friction braking controller 310, and vehicle motion controllers 312a, 312b in order to control acceleration and braking of the vehicle 100. The autonomous driving controller 318 further interfaces with a steering controller of the vehicle 100 to perform autonomous steering of the vehicle 100 according to any approach known in the art.

The autonomous driving controller 318 may receive voltage from one or both voltage sources 302a, 302b and may additionally or alternatively receive power from a third voltage source other than the voltage sources 302a, 302b.

FIG. 3B illustrates a redundant braking system 300b for a rear-wheel-drive (RWD) vehicle. As is apparent, the drive controller 306a for the front drive motor DMa and the front drive motor DMa may be omitted with other components functioning as described with respect to the redundant braking system 300a. FIG. 3C illustrates a redundant braking system 300c for a front-wheel-drive (FWD) vehicle. As is apparent, the drive controller 306b for a rear drive motor DMb and the rear drive motor DMb may be omitted with other components functioning as described with respect to the redundant braking system 300a.

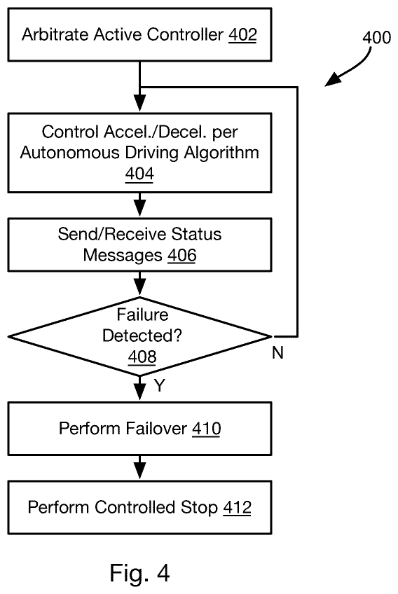

FIG. 4 illustrates a method 400 that may be executed using a redundant braking system, such as a redundant braking system 300a, 300b, 300c. The method 400 may be executed by the vehicle motion controllers 312a, 312b. Unless otherwise indicated, the recited actions are performed by whichever of the vehicle motion controllers 312a, 312b is currently the primary vehicle motion controller.

The method 400 may include arbitrating, at step 402, which of the vehicle motion controllers 312a, 312b are functioning. Step 402 may include verifying that both vehicle motion controllers 312a, 312b are functioning. For example, the autonomous driving controller 318 may receive status messages from both vehicle motion controllers 312a, 312b to verify that both vehicle motion controllers 312a, 312b are functioning. The autonomous driving controller 318 may select the primary vehicle motion controller 312a to be active. Alternatively, the vehicle motion controllers 312a, 312b may arbitrate between each other to see which is active.

The method 400 may include controlling acceleration and deceleration of the vehicle 100 at step 404. Step 404 may include using the autonomous driving controller 318 to select a determined amount of acceleration and deceleration of the vehicle 100. The primary vehicle motion controller 312a, 312b may then command an amount of torque from the drive motor(s) DMa, DMb, regenerative braking from the drive motor(s) DMa, DMb, and/or friction braking by the friction braking system FBS in order to achieve the determined amount of acceleration or deceleration.

Step 404 may be interleaved with performance of step 406, which includes receiving status messages from one or more components of the redundant braking system 300a, 300b, 300c. For example, status messages may be received from the voltage sources 302a, 302b, one or both drive motor controllers 306a, 306b, and the parking brake system 314. Status messages may be transmitted spontaneously by the components, such as at a predefined period. A component may transmit a status message in response to a periodic message transmitted by the autonomous driving controller 318.

The method 400 may include evaluating, at step 408, whether failure is detected. Failure of a component may be detected in response to any of (a) failure to receive a status message from the component, (b) a status message indicating failure of the component or a system controlled by the component, or (c) failure of a voltage source 302a, 302b supplying power to the component.

For example, a failure may be detected at step 408 in response to detecting failure of a voltage source 302a for a voltage domain 304a including the friction braking controller 310, failure to receive a status message from the friction braking controller 310, or a status message from the friction braking controller 310 indicating that a failure in the friction braking system FBS. A failure may be detected at step 408 in response to detecting failure of the primary vehicle motion controller 312a, 312b or a voltage source 302a of a voltage domain 304a including the vehicle motion controller 312a. Failure may be detected in response to detecting failure of a drive motor controller 306a, 306b or a voltage source 302a, 302b of a voltage domain 304a, 304b including a drive motor controller 306a, 306b. Failure of a drive motor controller 306a, 306b may be detected in response to the drive motor controller 306a, 306b transmitting a status message indicating failure of a drive motor DMa, DMb, power module 114, or other component of a drive unit 112. A failure may be detected at step 408 in response to failure of a CAN bus 316a, such as a loss of connectivity to one or more components over the CAN bus 316a.

In response to detecting failure at step 408, the method 400 may include performing failover at step 410. In the case of failure of the vehicle motion controller 312a, failover may include activating the vehicle motion controller 312b to commence functioning as the primary vehicle motion controller. In the case of failure of the friction braking controller 310, failover may include switching to using the parking brake system 314 and regenerative braking using one or both drive motor controllers 306a, 306b. In the case of failure of the friction braking controller 310 and all drive motor controllers 306a, 306b, failover may include switching over to the parking brake system 314 exclusively.

In response to detecting failure at step 408, the method 400 may include performing, at step 412, a controlled stop, such as using one or more components to which failover was performed at step 410. For example, in response to failure of the friction braking controller 310, step 412 may include performing a controlled stop using regenerative braking or a combination of regenerative braking and use of the parking brake system 314. In response to failure of the friction braking controller 310 and a loss of ability to perform regenerative braking, step 412 may include performing a stop using only the parking brake system 314. Loss of the ability to perform regenerative braking may result from the failure of all drive motor controllers 306a and/or 306b or failure of both vehicle motion controllers 306a, 306b.

Performing a controlled stop may include bringing the vehicle 100 to a stop at a rate that does not exceed the grip of wheels of the vehicle 100 and maintains dynamic stability of the vehicle 100, e.g., avoids rollover. Performing a controlled stop may include attempting to identify an unobstructed path to a side of a road on which the vehicle 100 and steering the vehicle 100 along the path, such as using the autonomous driving controller 318, if functional.

Using the parking brake system 314 to perform the controlled stop has the advantage of using a braking system that is already present in the vehicle 100 and is not simply present for purposes of redundancy. Therefore, the weight and cost of a completely redundant braking system is eliminated.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

While the foregoing is directed to embodiments of the present disclosure, other and further embodiments may be devised without departing from the basic scope thereof, and the scope thereof is determined by the claims that follow.

What is claimed is:

1. A vehicle, comprising:
a driving braking system configured to decelerate the vehicle;
an electronic parking brake system configured to maintain a position of the vehicle when parked; and
an autonomous driving controller configured to autonomously drive the vehicle, the autonomous driving controller further configured to:
detect failure of the driving braking system; and
in response to detecting failure of the driving braking system, perform a controlled stop using the electronic parking brake system.

2. The vehicle of claim 1, wherein the driving braking system is powered by a first voltage source and the electronic parking brake system is powered by a second voltage source different from the first voltage source.

3. The vehicle of claim 2, wherein the electronic parking brake system is configured to receive power from both the first voltage source and the second voltage source.

4. The vehicle of claim 2, wherein:
the vehicle further comprises:
one or more drive motors configured to propel the vehicle; and
a battery configured to supply current to the one or more drive motors; and
one of the first voltage source and the second voltage source is a direct current to direct current (DC/DC) converter coupled to the battery.

5. The vehicle of claim 4, wherein the battery is a first battery, the vehicle further comprising a second battery having an output voltage less than the first battery, the first voltage source and the second voltage source including the DC/DC converter and the second battery.

6. The vehicle of claim 5, wherein an output voltage of the second battery is 48 Volts or less.

7. The vehicle of claim 6, wherein the output voltage of the first battery is at least 200 Volts.

8. The vehicle of claim 1, wherein:
the vehicle further comprises:
one or more drive motors configured to propel the vehicle; and
one or more drive motor controllers configured to control supply of current to the one or more drive motors; and
the driving braking system comprises a friction braking system and the one or more drive motors for performing regenerative braking.

9. The vehicle of claim 8, wherein the autonomous driving controller is further configured to perform the controlled stop using the electronic parking brake system in response to both of (a) failure of the friction braking system and (b) failure of the one or more drive motor controllers during which the one or more drive motors are unable to perform the regenerative braking.

10. The vehicle of claim 1, wherein the autonomous driving controller is coupled to the driving braking system and the electronic parking brake system by a first bus and a second bus.

11. The vehicle of claim 10, wherein the first bus and the second bus are controller area network (CAN) busses.

12. The vehicle of claim 1, wherein:
the vehicle further comprises:
one or more drive motors configured to propel the vehicle;
one or more drive motor controllers configured to control supply of current to the one or more drive motors;
a first electronic control unit coupled to the one or more drive motor controllers, the first electronic control unit configured to function as a primary vehicle motion controller; and
a second electronic control unit coupled to the one or more drive motor controllers, the second electronic control unit configured to function as a secondary vehicle motion controller and perform a primary function other than as the secondary vehicle motion controller, the second electronic control unit configured to assume function as the primary vehicle motion controller in response to detecting failure of the first electronic control unit.

13. The vehicle of claim 12, further comprising a first voltage source and a second voltage source, the first electronic control unit configured to receive power from the first voltage source, and the second electronic control unit configured to receive power from the second voltage source.

14. A method comprising:
detecting, by an autonomous driving controller of a vehicle, failure of a driving braking system of the vehicle; and
in response to detecting failure of the driving braking system, perform a controlled stop using an electronic parking brake system.

15. The method of claim 14, wherein the driving braking system is powered by a first voltage source and the electronic parking brake system is configured to receive power from both the first voltage source and a second voltage source.

16. The method of claim 15, wherein:
the vehicle further comprises:
one or more drive motors configured to propel the vehicle; and
a battery configured to supply current to the one or more drive motors; and
one of the first voltage source and the second voltage source is a direct current to direct current (DC/DC) converter coupled to the battery.

17. The method of claim 14, wherein:
the vehicle further comprises:
one or more drive motors configured to propel the vehicle; and
one or more drive motor controllers configured to control supply of current to the one or more drive motors; and
the driving braking system comprises a friction braking system and the one or more drive motors for performing regenerative braking.

18. The method of claim 17, further comprising performing, by the autonomous driving controller, the controlled stop using the electronic parking brake system in response to both of (a) failure of the friction braking system and (b) failure of the one or more drive motor controllers during which the one or more drive motors are unable to perform regenerative braking.

19. The method of claim 14, wherein:
the vehicle further comprises:
one or more drive motors configured to propel the vehicle;
one or more drive motor controllers configured to control supply of current to the one or more drive motors;
a first electronic control unit coupled to the one or more drive motor controllers, the first electronic control unit configured to function as a primary vehicle motion controller; and
a second electronic control unit coupled to the one or more drive motor controllers, the second electronic control unit configured to function as a secondary vehicle motion controller and perform a primary function other than as the secondary vehicle motion controller; and
the method further comprises:
detecting, by the second electronic control unit, failure of the first electronic control unit; and
in response to detecting failure of the first electronic control unit, assuming, by the second electronic control unit, function as the primary vehicle motion controller.

20. The method of claim 19, wherein the first electronic control unit is configured to receive power from a first voltage source, and the second electronic control unit is configured to receive power from a second voltage source.
